(19) United States
(12) Patent Application Publication
(10) Pub. No.: US 2015/0130687 A1
(43) Pub. Date: May 14, 2015

(54) DISPLAY CONTROL APPARATUS FOR VEHICLE

(71) Applicant: JVC KENWOOD Corporation, Yokohama-shi (JP)

(72) Inventors: Kazuhiro KITAMURA, Yokohama-shi (JP); Minoru MURATA, Yokohama-shi (JP); Naotaka SHIMOSATO, Yokohama-shi (JP); Eiji AOYAMA, Yokohama-shi (JP)

(21) Appl. No.: 14/597,622

(22) Filed: Jan. 15, 2015

Related U.S. Application Data
(63) Continuation of application No. PCT/JP2013/004295, filed on Jul. 11, 2013.

(30) Foreign Application Priority Data
Jul. 20, 2012 (JP) 2012-162028
Jul. 20, 2012 (JP) 2012-162029

(51) Int. Cl. G02B 27/01; G01J 1/42

(52) U.S. Cl. CPC G02B 27/0101; G02B 27/0149; G01J 1/4204; G02B 2027/0118; G02B 2027/014; G02B 2027/0169
USPC 345/7

(57) ABSTRACT

A first illuminance sensor acquires the illuminance of environmental light outside a vehicle, and a second illuminance sensor acquires the illuminance of environmental light inside the vehicle. An image presentation unit controls the luminance of image display light generated from image signals of an image to be displayed, based on the luminance of environmental light acquired by the first illuminance sensor or the second illuminance sensor, and projects the image display light. The image presentation unit selects either the first illuminance sensor or the second illuminance sensor, based on a comparison result, which indicates a magnitude relation between the illuminance of environment light outside the vehicle acquired by the first illuminance sensor and an illuminance to be compared. And the image presentation unit controls the luminance of image display light, based on the illuminance of environmental light acquired by the selected illuminance sensor.

### CROSS REFERENCE TO RELATED APPLICATION

Priority is claimed to Japanese Patent Application No. 2012-162028, filed on Jul. 20, 2012, the entire content of which is incorporated herein by reference.

Priority is claimed to Japanese Patent Application No. 2012-162029, filed on Jul. 20, 2012, the entire content of which is incorporated herein by reference.

### BACKGROUND OF THE INVENTION

The present invention relates to a display apparatus for a vehicle (hereinafter referred to as “automotive display apparatus” or “vehicular display apparatus” also), and it particularly relates to an automotive display apparatus used to present an image, based on an image display light, as a virtual image to a user.

An automotive display apparatus, which is called a head-up display (hereinafter referred to as “HUD” also), is known in the art. The HUD is a display apparatus that displays items of information such that the items of information are being superimposed on an outside scenery by using an optical element called a combiner. Here, the combiner transmits the light entering from the exterior of a vehicle and, simultaneously, reflects an image projected from an optical unit placed inside the vehicle. The HUD can have the driver of the vehicle visually recognize the information on the image projected from the optical unit while the driver seeing and observing the outside scenery in front of him/her almost never needs to change his/her line of sight and focusing point. Thus, the HUD is recently attracting attentions as a display apparatus for use in a vehicle.

(1) Japanese Unexamined Patent Application Publication JPH10-278629.

There may be cases where the user's visibility drops when the image display light is superimposed or overlaid on the outside scenery in front of the user. This happens mainly because the brightness in the scenery outside the vehicle in front of the driver and the brightness of the image display light overlaid thereon are not well-balanced between them. For this reason, demanded is a technology capable of presenting an image, keeping well balance between the brightness in the exterior of the vehicle and the brightness of the image display light overlaid thereon, to the user (e.g., the driver of the vehicle).

### SUMMARY OF THE INVENTION

The present invention has been made in view of the foregoing circumstances, and a purpose thereof is to provide a technology capable of presenting an image, keeping well balance between the brightness in the scenery outside a vehicle and the brightness of image display light overlaid thereon.

In order to achieve the above-described purpose, one embodiment of the present invention relates to a display apparatus for a vehicle. The apparatus includes: a first illuminance sensor that acquiring illuminance of environmental light outside the vehicle; a second illuminance that acquires illuminance of environmental light inside the vehicle; an image presentation unit that controls luminance of image display light, generated from an image signal of an image to be displayed, based on the illuminance of environmental light acquired by the first illuminance sensor or the second illuminance sensor, and that projects the image display light; and a combiner onto which the image display light is projected. The image presentation unit selects either the first illuminance sensor or the second illuminance sensor, based a comparison result, which indicates a magnitude relation between the illuminance of environment light outside the vehicle acquired by the first illuminance sensor and an illuminance to be compared. And, based on the illuminance of environmental light acquired by the selected illuminance sensor, the image presentation unit controls the luminance of image display light.

### BRIEF DESCRIPTION OF THE DRAWINGS

Embodiments will now be described by way of examples only, with reference to the accompanying drawings, which are meant to be exemplary, not limiting and wherein like elements are numbered alike in several Figures in which:

FIG. 1 is a perspective view obtained when a head-up display, which is a display apparatus for a vehicle according to an embodiment of the present invention, is observed from a field of view within from a vehicle's passenger compartment;

FIG. 2 is a perspective view obtained when the head-up display of FIG. 1 is observed from a field of view directed from a windshield side;

FIG. 3 shows an internal structure of an optical unit together with light paths;

FIG. 4 shows an internal structure of an optical unit together with light paths;

FIG. 5 shows part of interior of an optical unit and part of interior of a substrate housing portion;

FIG. 6 shows a head-up display mounted to a right-hand drive vehicle with a projection unit and a combiner being detached therefrom;

FIG. 7 shows a head-up display where a substrate housing portion is replaced so that the head-up display can be used for a left-hand drive vehicle;

FIG. 8 shows a head-up display replaced so that the head-up display can be used for a left-hand drive vehicle;

FIG. 9 is a perspective view showing a attachment member with which to mount a substrate housing portion on a rear-view mirror;

FIG. 10 is a set of three orthographic views of an attachment plate in the attachment member of FIG. 9;

FIG. 11 is a perspective view of a head-up display mounted on a rear-view mirror;

FIG. 12 schematically shows a functional structure of a head-up display, which is an automotive display apparatus according to an embodiment of the present invention;

FIG. 13 schematically shows an internal structure of a drive unit according to an embodiment of the present invention;

FIG. 14 schematically shows an internal structure of a display control unit according to an embodiment of the present invention;

FIG. 15 is a graph to explain how to identify environmental light outside a vehicle by a light source management unit according to an embodiment of the present invention;

FIG. 16 is another graph to explain how to identify environmental light outside the vehicle by the light source management unit according to an embodiment of the present invention;

FIG. 17 is a flowchart to explain a flow of a process for selecting an illuminance sensor by a comparator according to an embodiment of the present invention; and

FIG. 18 is a cross-sectional view of an image display substrate housing portion cut along a cross section including an illuminance sensor.

### DETAILED DESCRIPTION OF THE INVENTION

The invention will now be described by reference to the preferred embodiments. This does not intend to limit the scope of the present invention, but to exemplify the invention.

Embodiments of the present invention will now be described with reference to the Figures. Specific numerical values and so forth shown in the embodiments are only exemplary for ease of understanding of the present invention and do not intend to limit the scope of the present invention except when stated explicitly. The components and functions practically identical to or equivalent to those shown in the disclosed patent specification and each Figure are given the same reference numerals or symbols, and the repeated explanation thereof is omitted. Also, the depiction of components or elements not directly related to the embodiments of the present invention is omitted in the Figures.

[External Structure of a Display Apparatus, for a Vehicle, According to an Embodiment]

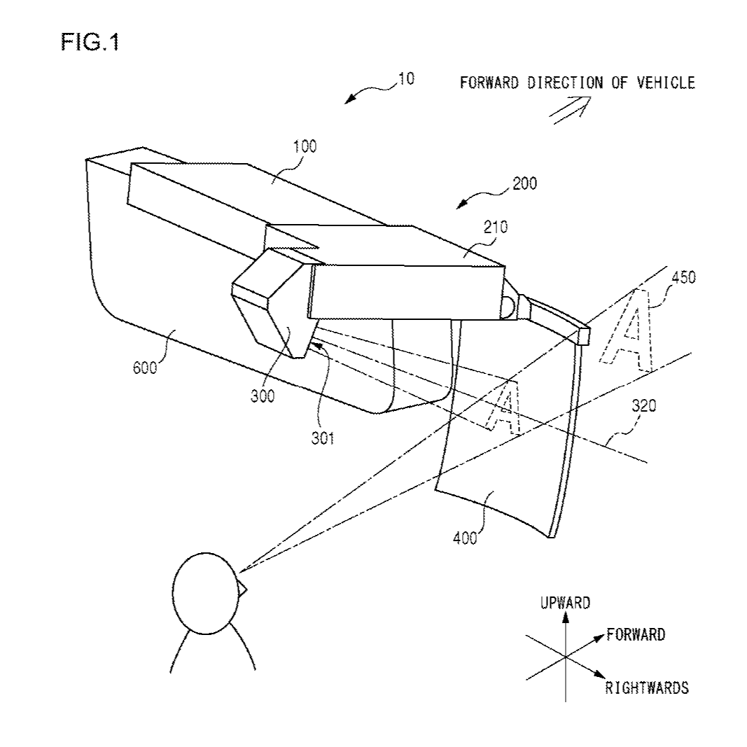

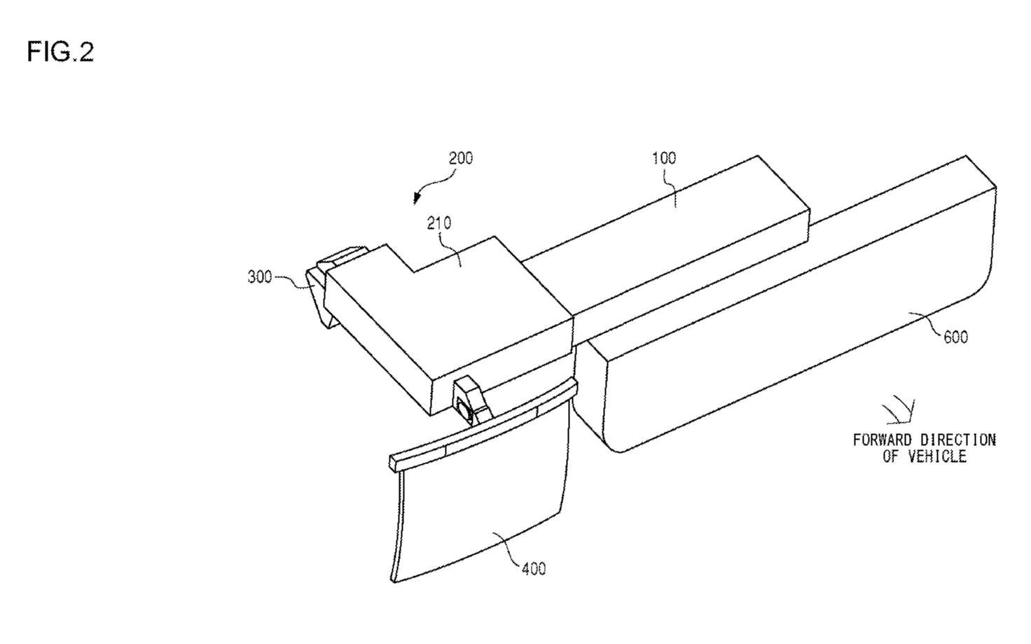

A head-up display (HUD), which is mounted on a rear-view mirror of a vehicle, is herein exemplified as the display apparatus, for the vehicle, according to the present embodiment. A description will be given of an external structure of the HUD with reference to FIG. 1 and FIG. 2. Hereinafter a display apparatus for a vehicle may be referred to as an “automotive display apparatus” or a “vehicular display apparatus” also. FIG. 1 is a perspective view showing a mode in which a head-up display (HUD) 10 according to the present embodiment is observed from a field of view directed toward a not-shown windshield of the vehicle from a rear-view mirror 600, to which the HUD 10 is mounted. FIG. 2 is a perspective view showing a mode in which the HUD 10 is observed from a field of view directed toward the rear-view mirror 600 from the not-shown windshield. In the following description, a front and a back direction, a left and a right direction, and an up and a down direction indicated herein and in the Figures respectively represent a frontward and a rearward direction of the vehicle, a left-side and a right-side direction thereof, and a first direction vertical to a road surface, where the vehicle is located, with the first direction being on a vehicle side and a second direction opposite to the first direction.

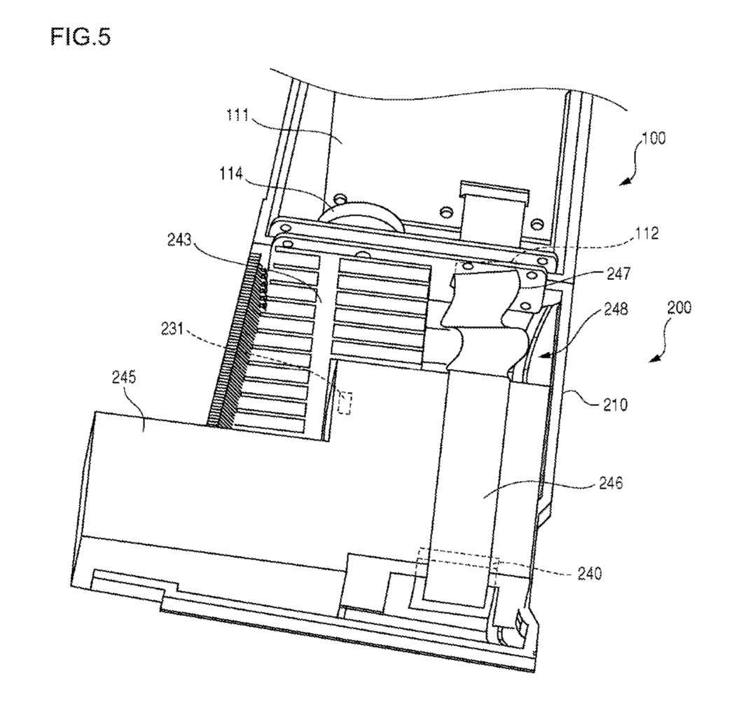

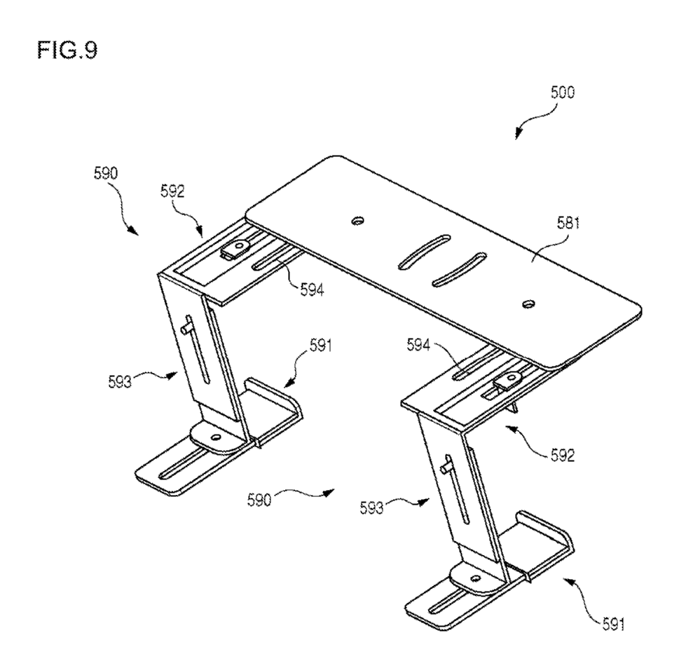

The HUD 10 generates an image signal related to an image displayed on a combiner 400 as a virtual image. The HUD 10 includes an image display substrate housing portion 100 that contains an image display circuit substrate 111 (see FIG. 5) for outputting the thus generated image signal to an optical unit 200. The image display circuit substrate 111 can receive an image signal, which is outputted by an external device 1600 (described later), such as a navigation device and a media reproduction device, to an image generation substrate housing portion 150, and which is then generated by the image generation substrate housing portion 150. The image display circuit substrate 111 can also perform a predetermined processing on the inputted signal and then output the processed signal to the optical unit 200. The image display substrate housing portion 100 is coupled to a attachment member 500 (see FIG. 9), which is one of constituent components of the HUD 10, and the rear-view mirror 600 is held by the attachment member 500. Thereby, the HUD 10 is mounted on the rear-view mirror 600. A detailed description will be later given of each mechanism concerning the coupling of the image display substrate housing portion 100 and the attachment member 500 and the holding of the attachment member 500 on the rear-view mirror 600. Note that, for ease of description and understanding of a whole structure of the HUD 10, the depiction of the attachment member 500 is omitted in FIG. 1 and FIG. 2. The image generation substrate housing portion 150 and the image display substrate housing portion 100 is connected by a cable 190.

The HUD 10 includes an optical unit 200 to which the image signal outputted from the image display circuit substrate 111 is inputted. The optical unit 200 includes an optical unit main body 210 and a projection unit 300. The optical unit main body 210 contains a light source 231, an image display element 240, various kinds of optical lenses and so forth, which will be described later. The projection unit 300 contains various kinds of projection mirrors and an intermediate image screen 360, which will be described later. The image signal outputted from the image display circuit substrate 111 is projected onto the combiner 400, which is of a concave shape, from a projection port 301 as an image display light by way of each of the aforementioned components of the optical unit main body 210 and each of the aforementioned components of the projection unit 300. In the present embodiment, described herein is an example where a liquid crystal on silicon (LCOS), which is a reflection-type liquid crystal display panel, is used as the image display element 240. Instead, a digital micromirror device (DMD) may be used as the image display element 240. In such a case where used is other than LCOS, the image display element 240 will be configured by an optical system and a drive circuit suited to the display element used. Also, a laser-type display apparatus using micro electro mechanical systems (MEMS) and the like may be used.

A user, who is the driver of the vehicle, recognizes the image display light projected thereon as the virtual image via the combiner 400. In FIG. 1, the projection unit 300 projects the image display light, which forms a character “A”, onto the combiner 400. By looking at the combiner 400, the user recognizes as if the character “A” were being displayed 1.7 to 2.0 meters away from the user in a frontward direction of the vehicle. In other words, the user recognizes a virtual image 450. Here, a central axis of the image display light projected onto the combiner 400 from the projection unit 300 is defined to be a projection axis 320.

Though the detailed description will be discussed later, the optical unit 200 is so configured as to be turnable relative to the image display substrate housing portion 100. Further, in the HUD 10 according to the present embodiment, the projection unit 300 and the combiner 400 are configured such that the directions in which they are mounted on and removed from predetermined surfaces of the optical unit main body 210 can be changed. In this patent specification, the image display substrate housing portion 100 combined with the optical unit 200 are sometimes called a “image presentation unit 50”. The image display substrate housing portion 100 and the optical unit 200 in the “image presentation unit 50” may be configured such that they are installed separately as shown in FIG. 1, for example, or may be configured such they are formed integrally with each other within the same casing that contains them.

[Internal Structure of a Display Apparatus, for a Vehicle, According to an Embodiment: Optical System]

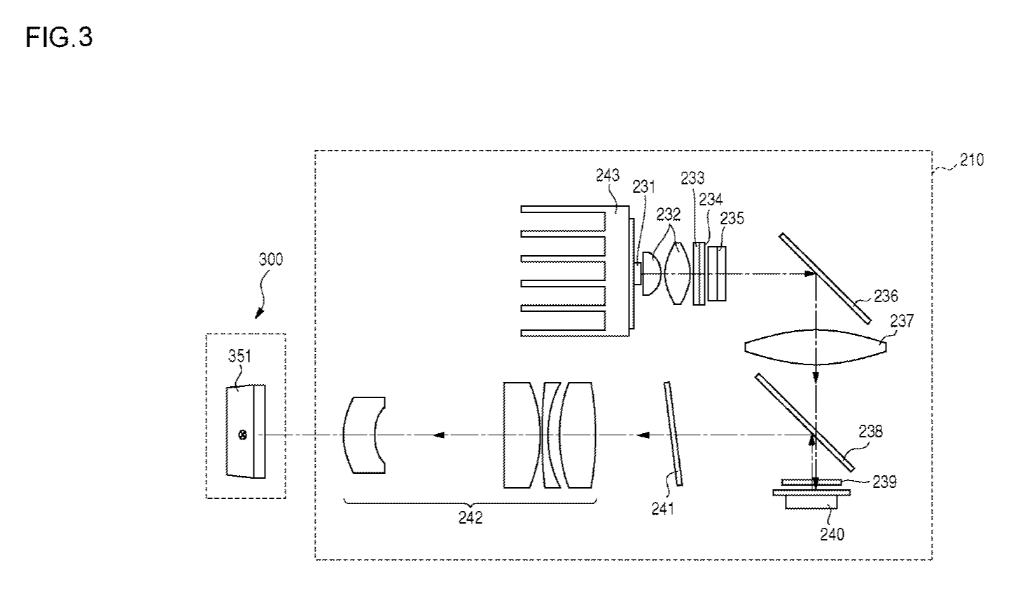

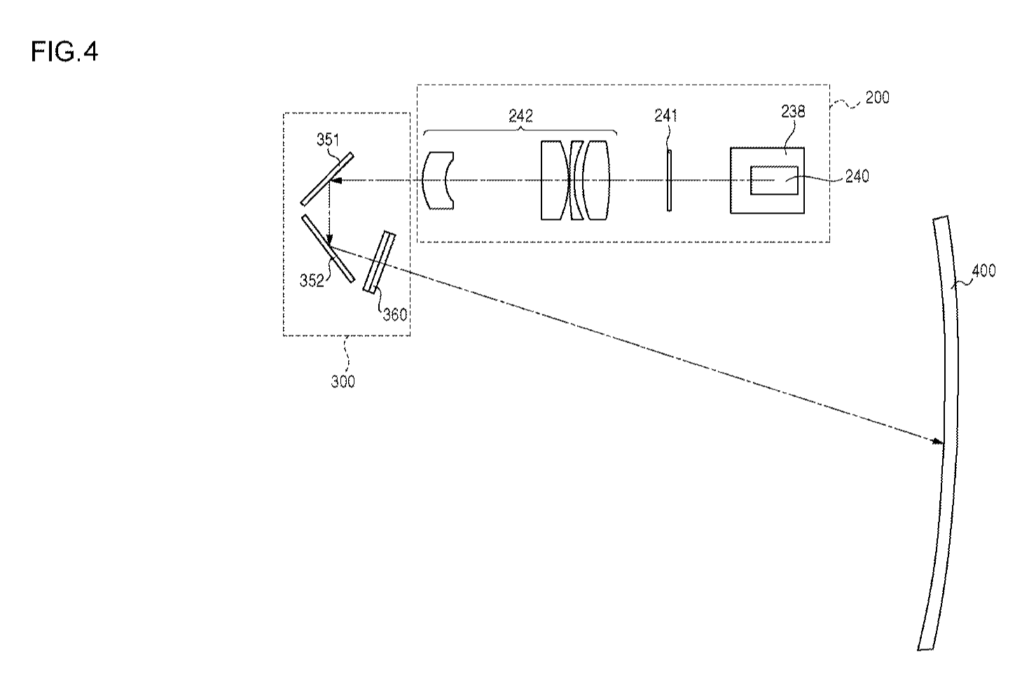

A description is now given of an internal structure of the HUD 10. FIG. 3 and FIG. 4 are diagrams for explaining the internal structure of the optical unit 200 of the above-described HUD 10. FIG. 3 shows an internal structure of the optical unit main body 210 and part of an internal structure of the projection unit 300, together with light paths of the image display light. FIG. 4 shows an internal structure of the projection unit 300 and part of an internal structure of the optical unit main body 210, together with light paths of the image display light projected up to the combiner 400.

A description is first given of the internal structure of the optical unit main body 210 and the light paths of the image display light, with reference to FIG. 3. The optical unit main body 210 includes a light source 231, collimate lenses 232, an ultraviolet-infrared ray (UV-IR) cut filter 233, a polarizer 234, a fly-eye lens 235, a reflecting mirror 236, a field lens 237, a wire grid polarization beam splitter 238, a quarter-wave plate 239, an analyzer 241, a projection lens group 242, and a heatsink 243.

The light source 231 is comprised of a light-emitting diode (LED) that emits three colors of white or blue, green and red. The heatsink 243 for radiating the heat generated as a result of light emission so as to be cooled is mounted on the light source 231. The light emitted from the light source 231 is converted by the collimate lenses 232 into parallel light. The UV-IR cut filter 233 absorbs the ultraviolet light and the infrared light from the parallel light that has passed through the collimate lenses 232. The polarizer 234 converts the light, which has passed through the UV-IR cut filter 233, into stable p-polarized light. Then the fly-eye lens 235 adjusts the light, which has passed through the polarizer 234, such that the brightness thereof is evenly distributed.

The reflecting mirror 236 reflects the light path of light, which has passed through each cell of the fly-eye lens 235, by 90 degrees. The light reflected by the reflecting mirror 236 is condensed by the field lens 237. The light condensed by the field lens 237 is irradiated to the image display element 240 by way of the wire grid polarization beam splitter 238 and the quarter-wave plate 239 that transmit the p-polarized light.

The image display element 240 has a red color filter, a green color filter and a blue color filter for each pixel. The light irradiated to the image display element 240 becomes a color associated with each pixel, is then modulated by a liquid crystal composition provided in the image display element 240, and thereby becomes s-polarized image display light so as to be irradiated toward the wire grid polarization beam splitter 238. The irradiated s-polarized light is reflected by the wire grid polarization beam splitter 238, thereby changing its light path. The reflected s-polarized light passes through the analyzer 241 and then enters the projection lens group 242.

The image display light, which has passed through the projection lens group 242, exits the optical unit main body 210 and then enters the projection unit 300. Then a first projection mirror 351 provided in the projection unit 300 changes the light path of the image display light that has entered the projection unit 300.

A description is now given of the internal structure of the projection unit 300 and the light paths of the image display light with reference to FIG. 4. The projection unit 300 includes a first projection mirror 351, a second projection mirror 352, and an intermediate image screen 360.

As discussed earlier, the light path of the image display light, which has passed through the wire grid polarization beam splitter 238, the analyzer 241 and the projection lens group 242 provided in the optical unit main body 210, is converted by the first projection mirror 351 and the second projection mirror 352 to a light path directed toward the combiner 400. Along these light paths, a real image based on the image display light reflected by the second projection mirror 352 is image-formed on the intermediate image screen 360. An image display light of the real image, which has been image-formed on the intermediate image screen 360, transmits the intermediate image screen 360 and is projected onto the combiner 400. As described above, the user comes to recognize a virtual image of this projected image display light ahead of him/her.

By employing the internal structure thereof as described above, the user can visually recognize the virtual image based on the image signal outputted from the image display circuit substrate 111 via the combiner 400 in a manner such that the virtual image is overlaid or superimposed onto an actual scenery.

[The Turning and the Attachment/Removal of the Combiner and the Projection Unit]

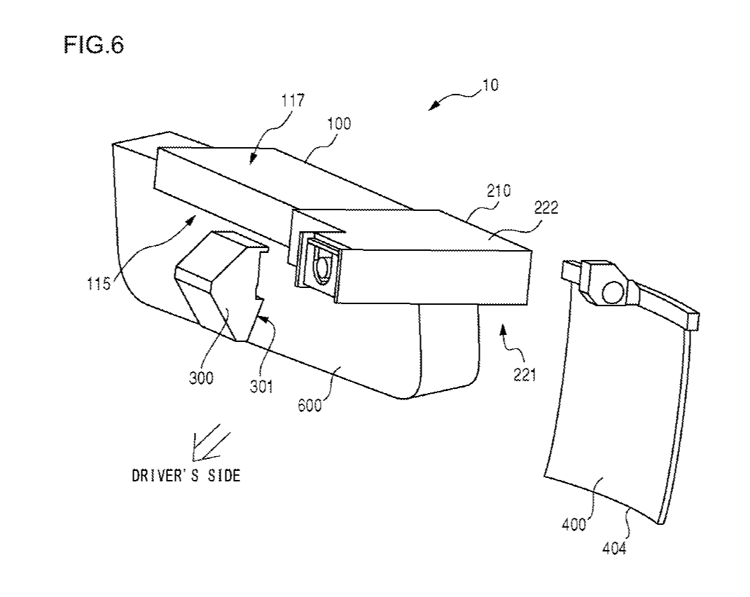

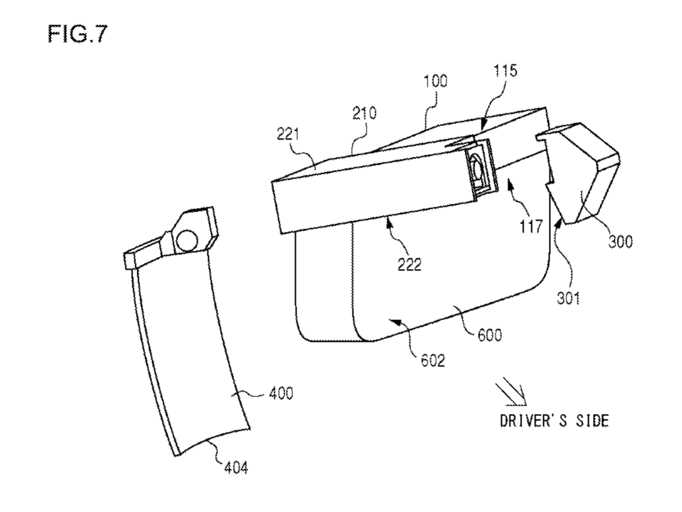

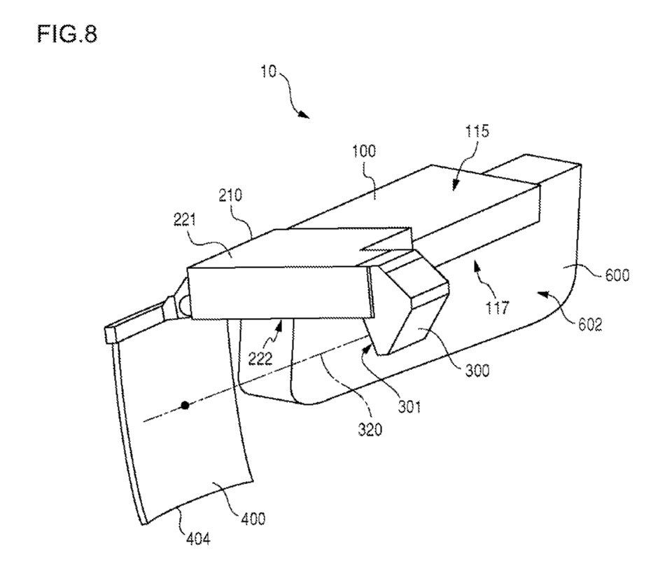

FIG. 6, FIG. 7 and FIG. 8 are diagrams for explaining two cases where the HUD 10 are mounted in two different mounting positions corresponding to a right-hand drive vehicle and a left-hand drive vehicle. FIG. 6 shows how the HUD 10 mounted to a right-hand drive vehicle looks like when the projection unit 300 and the combiner 400 are detached from the optical unit main body 210. In the HUD 10 mounted to the right-hand drive vehicle, the optical unit main body 210 and the combiner 400 are placed on a right side (i.e., a driver side) of the rear-view mirror 600 as viewed from the driver side. The image display substrate housing portion 100 has a first attachment surface 115 and a second attachment surface 117, disposed counter to the first attachment surface 115. And the image display substrate housing portion 100 is mounted on the rear-view mirror 600, as shown in FIG. 6, such that the first attachment surface 115 is orientated in a direction where the first attachment surface 115 is in contact with the not-shown attachment member 500. The optical unit main body 210 has a first main body surface 221 on the same side as the first attachment surface 115 of the image display substrate housing portion 100. A surface disposed counter to the first main body surface 221 is a second main body surface 222.

The HUD 10 shown in FIG. 6 is mounted to the rear-view mirror 600 in the following arrangement. That is, the first attachment surface 115 of the image display substrate housing portion 100 and the first main body surface 221 of the optical unit main body 210 face downward, and the projection port 301 of the projection unit 300 and a lower end 404 of the combiner 400 are on a first main body surface 221 side. Thus, the projection axis 320 is on the first main body surface 221 side (see FIG. 1).

FIG. 7 shows a HUD 10 mounted to a left-hand drive vehicle. As shown in FIG. 7, when the HUD 10 is so installed as to be used for a left-hand drive vehicle, the HUD 10 is mounted on the rear-view mirror 600 such that the second attachment surface 117 of the image display substrate housing portion 100 faces downward and such that the second attachment surface 117 is orientated in a direction where the second attachment surface 117 is in contact with the not-shown attachment member 500. In this case, the optical unit main body 210 and the combiner 400 are placed on a left side (i.e., a driver side) of the rear-view mirror 600 as viewed from the driver side.

FIG. 8 shows a HUD 10 mounted to a left-hand drive vehicle. The HUD 10 is mounted on the rear-view mirror 600 in a state such that the second attachment surface 117 of the image display substrate housing portion 100 and the second main body surface 222 of the optical unit main body 210 face downward (face the same side) and such that the projection port 301 of the projection unit 300 and the lower end 404 of the combiner 400 are on a second main body surface 222 side.

As shown in FIG. 6 and FIG. 8, the projection unit 300 and the combiner 400 can be placed on the optical unit main body 210 even though the projection port 301 and the lower end 404 are either on the first main body surface 221 side or the second main body surface 222 side. Also, as shown in FIG. 6 and FIG. 7, it is possible to change the mounting directions of the projection unit 300 and the combiner 400 by detaching the projection unit 300 and the combiner 400 from the optical unit main body 210. Also, though not shown in FIG. 6 to FIG. 8, the optical unit main body 210, the projection unit 300 and the combiner 400 are connected with each other by turning members, so that it is possible to change their mounting directions via the turning members. In other words, in the HUD 10, the mounting directions of the projection unit 300 and the combiner 400 relative to the optical unit main body 210 can be changed and then mounted with the changed directions. Thus, changing the mounting directions thereof allows the projection port 301, which emits the image display light, projected from the projection unit 300 onto the combiner 400, and the projection axis 320 of the image display light along the projection direction to be arranged and set on either the first main body surface 221 side or the second main body surface 222 side.

Even though, as shown in FIG. 8, the second attachment surface 117 faces downward, the projection unit 300 can be properly placed while the projection port 301 of the projection unit 300 lies on the second main body surface 222 side of the optical unit main body 210. Hence, the image display light is projected in a downward direction from the optical unit main body 210. This means that the projection axis 320 is on the second main body surface 222 side.

As described above, the projection unit 300 and the combiner 400 can be mounted to the optical unit main body 210 even though the projection port 301 and the lower end 404 are either on the first main body surface 221 side or the second main body surface 222 side of the optical unit main body 210. In other words, the projection unit 300 and the combiner 400 can be mounted thereto while the projection port 301 of the projection unit 300 and the lower end 404 of the combiner 400 are each in a position changed by 180 degrees relative to one of the surfaces of the optical unit main body 210 (the first main body surface 221 or the second main body surface 222). The mounting positions of the projection unit 300 and the combiner 400 relative to the optical unit main body 210 can be changed, and the mounting positions thereof relative to the first attachment surface 115 (or the second attachment surface 117) of the image display substrate housing portion 100 can also be changed.

When the projection unit 300 and the combiner 400 are mounted thereto by changing their respective mounting positions thereof by 180 degrees relative to the optical unit main body 210, the orientation of an image (virtual image) visible on the combiner 400 may be possibly changed by 180 degrees as compared with the image before the change of the mounting positions. In the light of this, the projection unit 300 in the HUD 10 corrects the orientation of the image by detecting the orientations and/or the mounting position of the projection unit 300 or the combiner 400 and by properly operating on an operation part of a not-shown control module such as a remote control unit. As a result, the image display circuit substrate 111 outputs an image signal whose orientation has been correctly changed as compared with that before the change of the mounting positions.

For example, in the HUD 10 mounted as shown in FIG. 6, the orientation of an image outputted from the projection port 301 of the projection unit 300 in a mounting position on the first main body surface 221 side is made to differ, by 180 degrees, from the orientation of an image outputted from the projection port 301 of the projection unit 300 in a mounting position on the second main body surface 222 side, and vice versa. This makes it possible to have the driver see images having the same orientation in the event that the mounting position of the projection unit 300 is changed relative to the optical unit main body 210. This is achieved by a display adjustment unit 1240 in an image display unit (described later).

Thereby, the image display element 240 outputs an image by changing the orientation (e.g., vertical/horizontal direction, 180 degrees) of the image according to the mounting position of the projection unit 300. Thus, the driver can visually recognize the image (virtual image) in the event that the mounting position is changed.

[Rear-View Mirror Attachment Member]

A detailed description is now given of a attachment member 500 with which to mount the HUD 10 on the rear-view mirror 600. FIG. 9 shows the attachment member 500 with which to mount the HUD 10 on the rear-view mirror 600. As shown in FIG. 9, the attachment member 500 has a pair of holding portions 590 (a holding pair 590), which is so fixed to the rear-view mirror 600 as to hold the rear-view mirror 600 tightly, and a attachment plate 581 with which to mount the holding pair 590 and the image display substrate housing portion 100. The holding portions 590 include two lower side holding mechanisms 591, two upper side holding mechanisms 592, height adjustment parts 593, and position adjustment grooves 594. Here, the lower side holding mechanism 591 has a claw that is slidable back and forth for the purpose of holding a lower end of the rear-view mirror 600. The upper side holding mechanism 592 has a claw that is slidable back and forth for the purpose of holding an upper end of the rear-view mirror 600. The height adjustment part 593 is vertically slidable for the purpose of vertically holding the rear-view mirror 600 from behind. The position adjustment groove 594 is a long hole (slit) for the purpose of adjusting the position of the attachment plate 581 relative to the holding portions 590, and the position adjustment grooves 594 are located on an upper surface on which the attachment plate 581 is placed. Here, the attachment plate 581 is so placed as to lie across the respective upper surfaces of the pair of holding portions 590, and is mounted such that a pair of protrusions 584 (described later) of the attachment plate 581 are engaged with the position adjustment grooves 594.

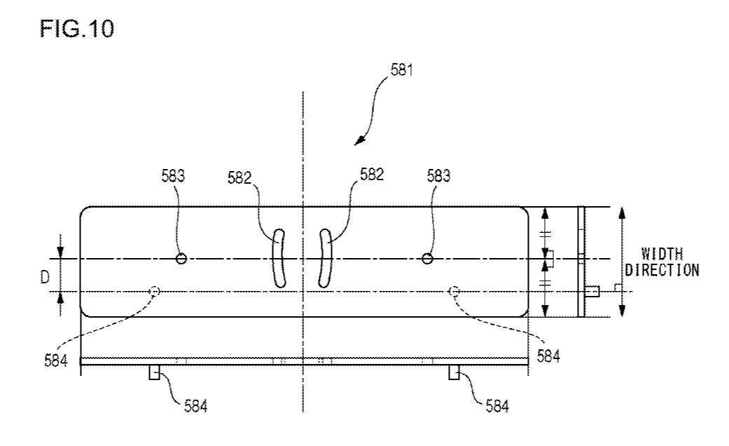

FIG. 10 are three orthographic views of the attachment plate 581 in the attachment member 500 shown in FIG. 9. As shown in FIG. 10, the attachment plate 581 is formed of an approximately rectangular plate-like member as a whole. A flat surface of the attachment plate 581, which is the attachment surface thereof, has circular-arc holes 582, which are a pair of arc-shape holes having different orientations, central holes 583, which are a pair of holes formed respectively in the positions serving as the centers of circles based on the arcs of the circular-arc holes 582, and the protrusions 584. Here, the protrusions 584, located on the back surface side of the attachment plate 581, are formed such that, when the attachment plate 581 is mounted to the holding portions 590, the protrusions 584 are fitted into the position adjustment grooves 594 formed on the holding portions 590; thereby the attachment plate 581 is slidable by way of the protrusions 584, which are movably engaged with the position adjustment grooves 594, in longitudinal directions of the position adjustment grooves 594.

The central holes 583 are formed on a center line of a width direction, which is a direction perpendicular to a straight line connecting the pair of protrusions 584 of the attachment plate 581. In contrast to this, the pair of protrusions 584 are not provided on the center line of the aforementioned width direction but placed in positions spaced away by a certain distance (offset D) from the central line in the width direction. This allows the sliding ranges of the attachment plate 581 to greatly differ between a first state and a second state and therefore allows an adjustable range of positions of the image display substrate housing portion 100 to be enlarged. Here, the first state is a state where the attachment plate 581 is mounted such that the respective protrusions 584 are brought closer to the height adjustment parts 593 than the respective central holes 583. The second state is a state where the first state is rotated by 180 degrees, with a direction vertical to the surface of the attachment plate 581 being set as the rotation axis and with the pair of protrusions 584 facing downward, and two ends in the width direction are interchanged and used. More specifically, the second state is the state where the attachment plate 581 is mounted such that the protrusions 584 are located farther from the height adjustment parts 593 than the central holes 583.

The distance between the rear-view mirror 600 and a vehicle's windshield varies depending on the type of vehicle. Thus, as described above, the pair of protrusions 584 are placed in positions away from the central line by the offset D. This allows the degree of freedom of positions in fixing the HUD 10 to the rear-view mirror 600 in a front-back direction to increase, so that the HUD 10 can be mounted on various types of vehicles. Also, provision of a plurality of holding portions 590 (a single pair of holding portions in the present embodiment) allows the HUD 10 to be appropriately attached to an increased number of various types of vehicles.

Note that the distance between the pair of holding portions 590 may be determined such that the distance between the two position adjustment grooves 594 is equal to the distance between the two protrusions 584 of the attachment plate 581. Also, the pair of holding portions 590 can be arranged such that the distance between the two position adjustment grooves 594 is less than the distance between the two protrusions 584 thereof. Suppose that the pair of holding portions 590 are arranged in this manner. Since, in this case, the distance between the pair of protrusions 584 remains unchanged, the attachment plate 581 is obliquely mounted by necessity and therefore the attachment plate 581 can be mounted by varying the angle formed relative to the longitudinal direction. In other words, the attachment plate 581 can be obliquely mounted by turning the attachment plate 581 and the image display substrate housing portion 100 along a plane surface of the attachment plate 581. In this manner, a plurality of holding portions 590 (a single pair of holding portions in the present embodiment) are provided and then the distance between the plurality of holding portions 590 is adjusted. This configuration and arrangement can realize an increased number of various mounting positions.

When the image display substrate housing portion 100 is to be mounted, a surface of the attachment plate 581 (the surface thereof where no protrusions 584 is provided) and the first attachment surface or the second attachment surface of the image display substrate housing portion 100 are first arranged such that the surface of the attachment plate 581 overlaps with the first attachment surface or the second surface. Then, setscrews 118 (securing members) are inserted through the circular-arc holes 582 and the central holes 583, located in the centers of the arcs of the circular-arc holes 582, and the image display substrate housing portion 100 is secured by fastening the setscrews 118. When the image display substrate housing portion 100 is secured by fastening the setscrews 118, the image display substrate housing portion 100 is turnable about the centers of the central holes 583 on the surface of the attachment plate 581, and adjusted is a direction where the normal line of a surface of the attachment plate 581 of the image display substrate housing portion 100 serves as a rotation axis. At this time, the image display substrate housing portion 100, the optical unit 200 and the combiner 400 are integrally turned with the central holes 583 as the centers. Thus, the driver can adjust the mounting angle (where the normal line of the surface of the attachment plate 581 serves as the rotation axis) so that the image (virtual image) displayed through the combiner 400 can be set in a visually recognizable position. A central angle of each circular-arc hole 582 is determined such that the central angle thereof lies within a sufficient range of angles at which the driver can adjust the image (virtual image), displayed through the combiner 400, in a visually recognizable position. The central angle of each circular-arc hole 582 is more preferably determined such that the central angle thereof is within a range of angles at which the combiner 400 does not come in contact with the windshield.

Assume here that an arc central direction of the circular-arc hole 582 is defined to be an internal side and that the reverse direction of the arc central direction is defined to be an external side. Then, in the present embodiment, the pair of circular-arc holes 582 are arranged such that the internal sides thereof face each other. However, depending on the position where the image display substrate housing portion 100 is secured by fastening the setscrews 118, the pair of circular-arc holes 582 may be arranged such that the external sides thereof face each other.

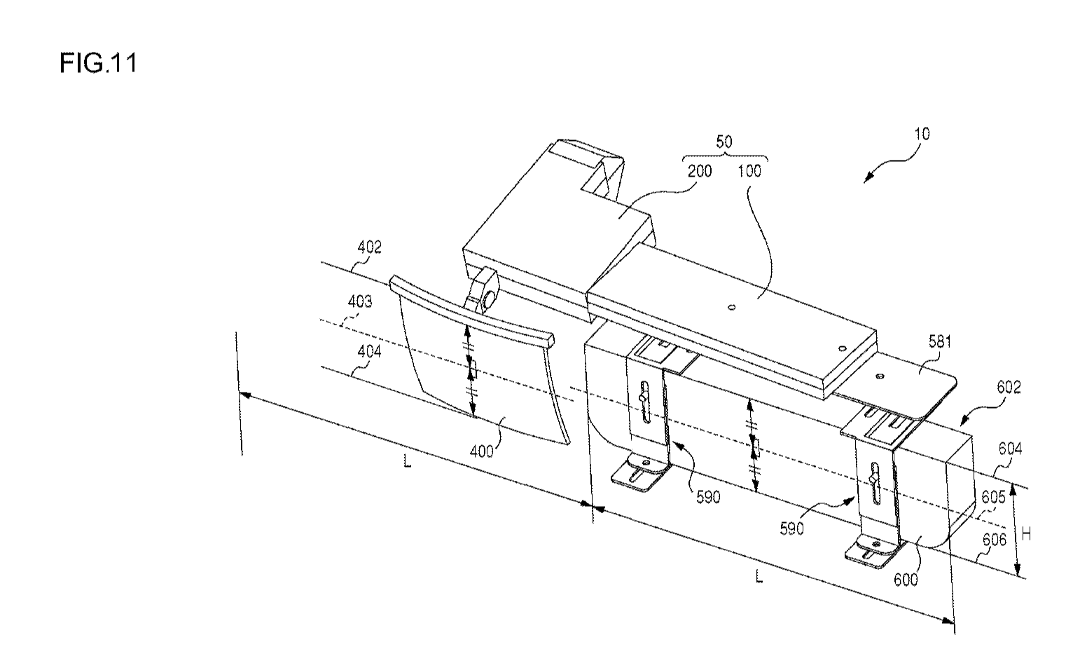

FIG. 11 shows a HUD 10 mounted on the rear-view mirror 600. The holding portions 590 of the attachment member 500 hold tightly an upper end of the rear-view mirror 600 and a lower end thereof from a back side of the rear-view mirror 600 (the back side thereof being the side where no mirror is provided) in two positions. And the protrusions 584 are fitted into the position adjustment grooves 594 formed on the upper side holding mechanism 592 of the holding portions 590. Thereby, the attachment plate 581 is mounted so that the position thereof in a longitudinal direction of the position adjustment groove 594, mainly in a direction vertical to a mirror surface of the rear-view mirror 600, can be adjusted. Also, the attachment plate 581 is secured so that the angle, where the normal line of the attachment plate surface of the image display substrate housing portion 100 serves as the rotational axis, can be adjusted.

As shown in FIG. 11, a first illuminance sensor 1310a and a second illuminance sensor 1310b are respectively provided on a front surface, which is one of the surfaces constituting the casing (housing) of the image display substrate housing portion 100, and a back surface, disposed counter to the front surface. Here, the front surface of the casing is the surface thereof on a traveling direction side of the vehicle when the image display substrate housing portion 100 is mounted on the rear-view mirror 600. The first illuminance sensor 1310a and the second illuminance sensor 1310b are hereinbelow generically referred to as “illuminance sensor 1310” or “illuminance sensors 1310” unless otherwise distinguished therebetween. A detailed description will be given later of the installation positions of the illuminance sensors 1310.

A description is now given of a relation between the position of the rear-view mirror 600 and the position of the combiner 400 with reference to FIG. 11. The description thereof is given hereinbelow on the assumption that the longitudinal direction of the rear-view mirror 600 is parallel to a horizontal plane and the mirror surface is vertical to the horizontal plane. Also, a line, which passes through a center in the vertical direction of the rear-view mirror 600 and which is parallel to a lateral direction of the rear-view mirror 600, is called a rear-view-mirror central line 605. Also, a line, which passes through a center in the vertical direction of the combiner 400 and which is parallel to a lateral direction of the combiner 400, is called a combiner central line 403.

In the present embodiment, the observation angle of the combiner 400 is adjustable, and the adjustment of the observation angle of the combiner 400 allows a relative height of the combiner 400 to the height of the rear-view mirror 600 to vary. A relative height in between the combiner 400 and the rear-view mirror 600 can be rephrased as a difference in height between the combiner central line 403 and the rear-view-mirror central line 605. If, for example, the combiner central line 403 is in a position higher than that of the rear-view-mirror central line 605, the combiner 400 can be said to be located in a position relatively higher than the rear-view mirror 600.

It is preferable that a positional condition of the combiner 400 explained hereunder be met in all positions of the combiner 400 in a usage state (where an image is projected and the image is visible by the user). In other words, although the positional condition is preferably met in all observation angles that the combiner 400 can possibly form, a sufficient effect can be achieved as long as the positional condition is met when the height thereof is at least an average height of all relative heights to the height of the rear-view mirror 600, which the combiner 400 can possibly be. Suppose, for example, the relative height of the combiner 400 with respect to the height of the rear-view mirror 600 can be adjusted in positions ranging from a height 5 cm higher than the rear-view-mirror central line 605 to a height 5 cm lower than the rear-view-mirror central line 605. Then, the positional condition will be preferably met when the height of the combiner central line 403 is identical to that of the rear-view-mirror central line 605.

Also, suppose that the relative height of the combiner 400 with respect to the height of the rear-view mirror 600 is fixed with fastening screws or the like so that the relative height thereof cannot be adjusted. Namely, suppose that the HUD 10 is configured such that, when the HUD 10 is mounted on the rear-view mirror 600 of the vehicle, the relative height of the combiner 400 with respect to the height of the rear-view mirror 600 is fixed (the height thereof is uniquely determined). Then, in the fixed position, the positional condition (described below) of the combiner 400 is preferably met.

Also, as shown in FIG. 11, the rear-view mirror 600 has a length L in the lateral direction (the longitudinal direction) and a height H in the vertical direction.

[Functional Configuration of an Image Display Control Apparatus]

A description has been given of the features and mechanism of the HUD 10 according to an embodiment of the present invention. A description is now given of an internal functional configuration of the HUD 10 according to the embodiment of the present invention. More specifically, the HUD 10 according to an embodiment of the present invention is herein considered and regarded as an image display control apparatus, and the function configuration thereof is now described.

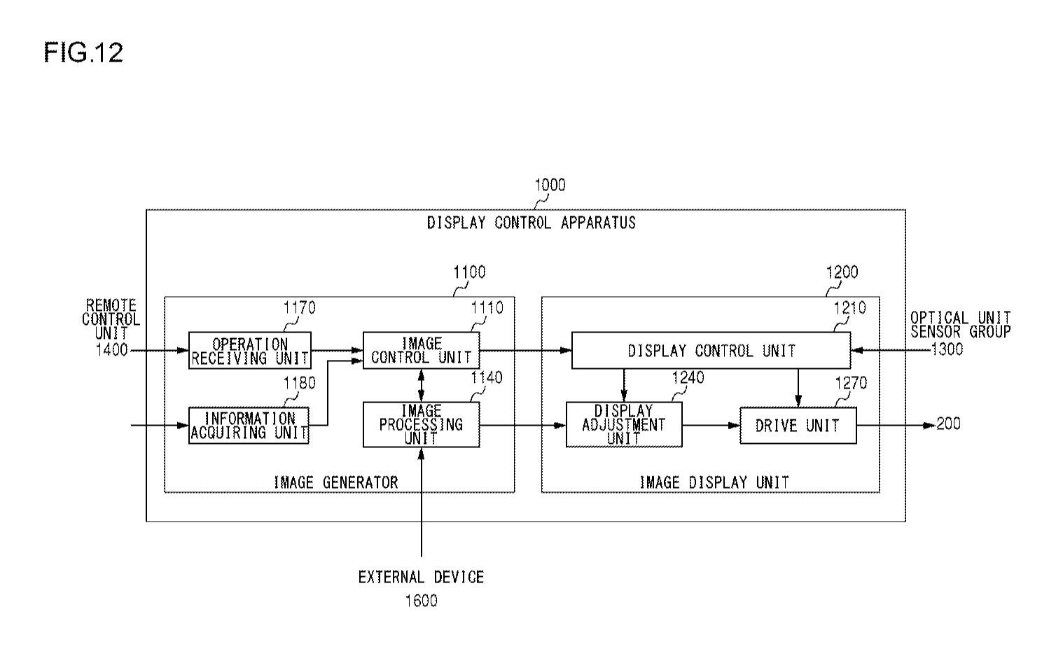

FIG. 12 schematically shows a functional structure of a HUD 10, which is an automotive display apparatus according to an embodiment of the present invention. A display control apparatus 1000 includes an image generator 1100 and an image display unit 1200.

The image generator 1100 is realized by an image generation circuit, which is mounted to a not-shown image generator board in the image generation substrate housing portion 150. The image generator 1100 includes an image control unit 1110, an image processing unit 1140, an operation receiving unit 1170, and an information acquiring unit 1180.

The operation receiving unit 1170 is an interface that receives the operations of a user who is a passenger or the driver of a vehicle. The operation receiving unit 1170 receives user's operation instructions via a remote control unit and operation buttons (both not shown in the Figures). A group of in-vehicle sensors includes, for example, a vehicle speed sensor, a steering angle sensor, a parking brake sensor, a raindrop sensor, a sensor for operations of wipers, and a sensor for operations of turning indicators. Each of these sensors is an example of a group of in-vehicle sensors. Thus, the in-vehicle sensor group does not need to include all of them and may include sensors other than these mentioned above. Which particular sensors to use may be determined according to usage scenes assumed in the HUD 10 according to an embodiment.

The image control unit 1110 controls an operation of the image processing unit 1140, based on the user's instructions acquired by the operation receiving unit 1170 and the information, concerning the traveling environment of a vehicle, acquired by the information acquiring unit 1180. For example, the image processing unit 1140 converts an image acquired from an external device 1600 into a format suitable for outputting to the image display unit 1200 (described later), and generates an on-screen display (OSD) that displays a setting screen of the display control apparatus 1000 to the user. The images acquired from the external device 1600 are, for example, navigation images acquired from a car navigation system, images acquired from a DVD (Digital Versatile Disc) player, navigation images acquired from a smartphone, images acquired from an on-vehicle camera, or the like. Those images or pictures are exemplary information acquired by the image processing unit 1140. Which particular information to acquire may be determined according to the usage scenes assumed in the HUD 10 according to an embodiment.

For example, while under the control of the image control unit 1110, the image processing unit 1140 controls the outputting of images acquired from the external device 1600 to the image display unit 1200, and overlays an image acquired from the external device 160 onto an OSD so as to be outputted to the image display unit 1200.

A description is now given of the image display unit 1200 in the display control apparatus 1000.

The image display unit 1200 is realized by an image display circuit, which is mounted to the above-described image display circuit substrate 111. The image display unit 1200 includes a display control unit 1210, a display adjustment unit 1240, and a drive unit 1270.

The display control unit 1210 acquires, via the image control unit 1110, the user's instructions acquired by the operation receiving unit 1170 and the information, concerning the traveling environment of the vehicle, acquired by the information acquiring unit 1180. The display control unit 1210 also acquires information, concerning the illuminance of environmental light of the vehicle, from the illuminance sensors 1310 in the group of optical unit sensors 1300. The display control unit 1210 further acquires a temperature of the light source 231 from a not-shown temperature sensor in the group of optical unit sensors 1300.

While under the control of the display control unit 1210, the display adjustment unit 1240 adjusts the image acquired from the image processing unit 1140. If, for example, the projection port 301 of the projection unit 300 is changed from a first state to a second state, an image signal of an image where the orientation of the image to be outputted has been reversed by 180 degrees, is generated. Here, the first state is a state where the projection port 301 thereof is mounted in a mounting position located on the first main body surface 221 side, and the second state is a state where the projection port 301 thereof is mounted in a mounting position located on the second main body surface 222 side.

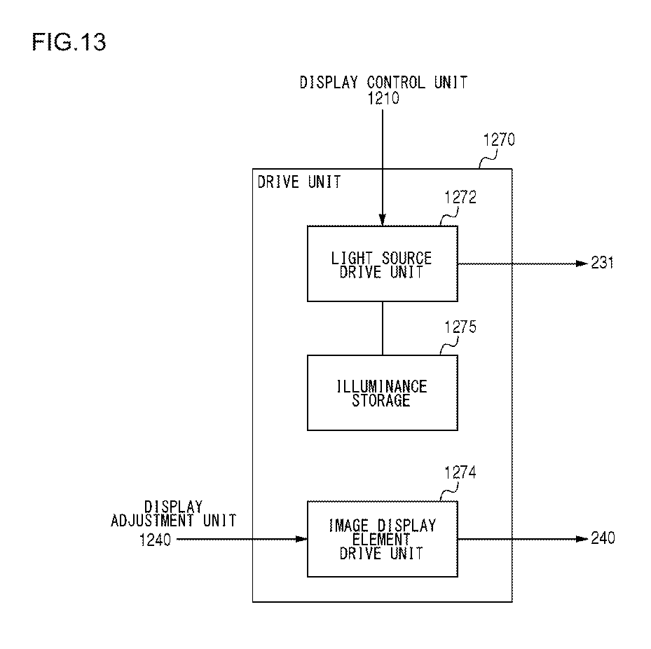

The drive unit 1270 controls an operation of the image display element 240 and an amount of luminescence of the light source 231. FIG. 13 schematically shows an internal structure of the drive unit 1270 according to an embodiment of the present invention. The drive unit 1270 includes the light source drive unit 1272 and an image display element drive unit 1274.

The image display element drive unit 1274 acquires the image signal, to be displayed, from the display adjustment unit 1240 and then outputs it from the above-described image display element 240. While under the control of the display control unit 1210, the light source drive unit 1272 controls the quantity of light outputted by the light source 231. More specifically, if, for example, the illuminance of environmental light acquired by the illuminance sensor 1310 is large, the display control unit 1210 controls the light source drive unit 1272 such that the quantity of light outputted by the light source 231 is larger than when the illuminance of environmental light is small. This increases the light quantity of image display light projected onto the combiner 400, when the outside of the vehicle is bright such as when it is the daytime under a clear sky, and therefore the visibility of image display light improves. If, conversely, the outside of the vehicle is dark like night, the light quantity of image display light projected onto the combiner 400 is reduced and therefore the visibility of scenery outside the vehicle improves. In this manner, the light quantity of image display light projected onto the combiner 400 is adjusted depending on the environmental light of the vehicle and therefore the visibility of both the scenery outside the vehicle and the virtual image displayed thereon in an overlaid manner can be enhanced.

[Installation Positions of the Illuminance Sensors and Control of the Luminance of the Light Source]

As described above, the display control unit 1210 according to the present embodiment controls the quantity of light outputted by the light source 231, based on the output values of the illuminance sensors 1310. Thus, the illuminance sensors 1310 are preferably installed in the positions such that the environmental light of the vehicle can be appropriately acquired. With reference to FIG. 11 again, a description is given hereunder of the installation positions of the illuminance sensors 1310 and the control of the luminance of the light source 231 based on the illuminance (brightness) of environmental light.

A description is first given of the control of the luminance of the light source 231.

As shown in FIG. 11, the first illuminance sensor 1310a and the second illuminance sensor 1310b are provided on the back surface and the front surface of the casing of the image display substrate housing portion 100, respectively. The first illuminance sensor 1310a placed on the back surface of the casing of the image display substrate housing portion 100 mainly measures the environmental light outside the vehicle. The second illuminance sensor 1310b placed on the front surface of the casing of the image display substrate housing portion 100 mainly measures the environmental light inside the vehicle.

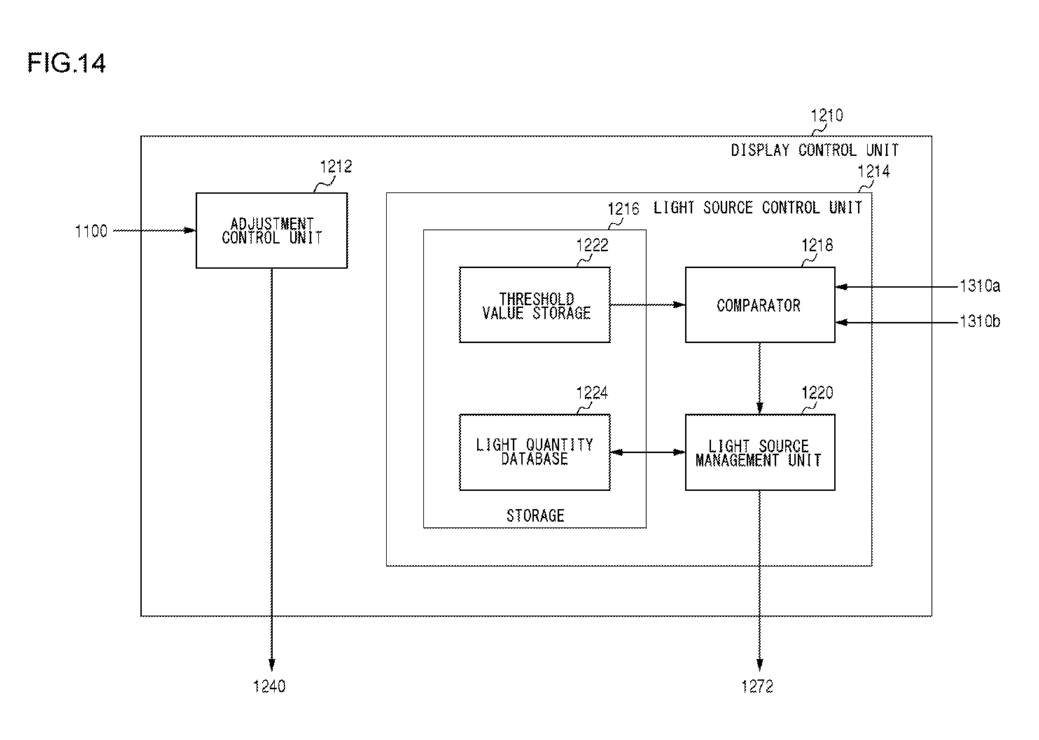

FIG. 14 schematically shows an internal structure of the display control unit 1210 according to an embodiment. The display control unit 1210 includes an adjustment control unit 1212 and a light source control unit 1214.

The adjustment control unit 1212 acquires the user's instructions acquired, from the image control unit 1110, by the operation receiving unit 1170 and the information, concerning the traveling environment of the vehicle, acquired by the information acquiring unit 1180, and then controls an operation of the display adjustment unit 1240, based on the acquired information.

The light source control unit 1214 controls an operation of the light source drive unit 1272 in the drive unit 1270. In order to achieve this, the light source control unit 1214 includes a storage 1216, a comparator 1218, and a light source management unit 1220.

The comparator 1218 acquires the illuminances measured respectively by the first illuminance sensor 1310a provided on the back surface of the casing of the image display substrate housing portion 100 and the second illuminance sensor 1310b provided on the front surface of the casing thereof. Then the comparator 1218 compares the magnitude of the illuminance measured by the first illuminance sensor 1310a with the magnitude thereof measured by the second illuminance sensor 1310b. Finally, the comparator 1218 selects an illuminance sensor 1310 (namely, the first illuminance sensor 1310a or the second illuminance sensor 1310b), whichever has measured an illuminance value to be outputted to the light source management unit 1220, based on a comparison result. Here, the comparison result indicates the magnitude relation between the illuminance measured by the first illuminance sensor 1310a and that measured by the second illuminance sensor 1310b.

More specifically, the comparator 1218 compares the illuminance measured by the first illuminance sensor 1310a with the illuminance measured by the second illuminance sensor 1310b to see if one of them is greater than, equal to, or less than the other in the magnitude of illuminance thereof, and then selects either the first illuminance sensor 1310a or the second illuminance sensor 1310b, whichever has a greater measured illuminance. And the comparator 1218 outputs the measured value of illuminance of the selected illuminance sensor 1310 to the light source management unit 1220.

The light source management unit 1220 acquires the illuminance of environmental light, which is an output value of the illuminance sensor 1310 selected by the comparator 1218. Based on the acquired illuminance of environmental light, the light source management unit 1220 acquires the luminance of light to be outputted by the light source 231. A description is given hereinbelow how the light source management unit 1220 sets the luminance of light to be outputted by the light source 231.

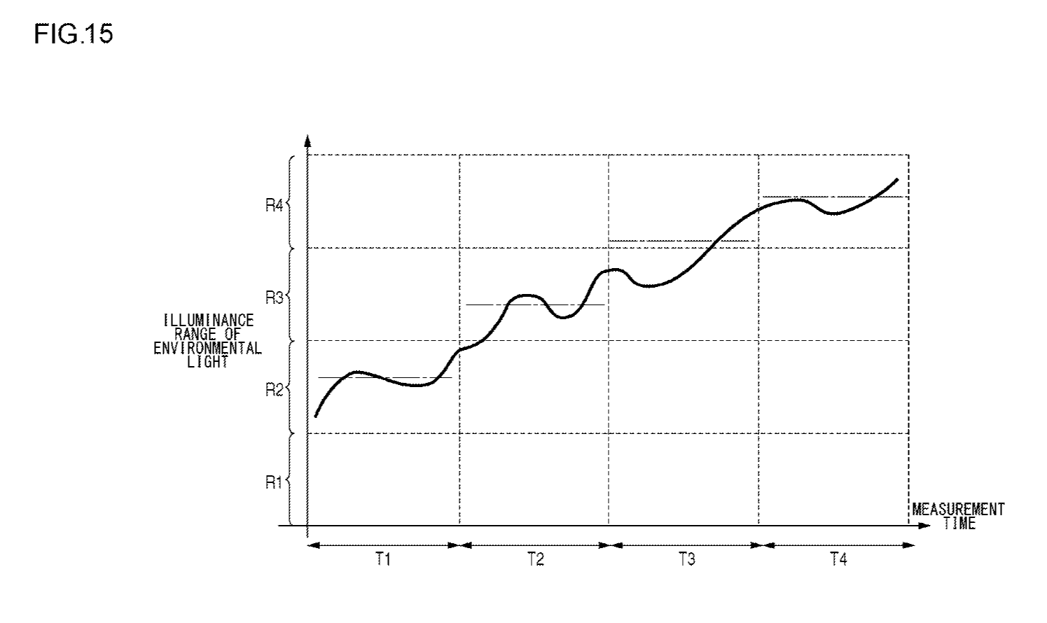

FIG. 15 is a graph to explain how to identify the environmental light outside the vehicle's passenger compartment (i.e., outside the vehicle) by the light source management unit 1220 according to the present embodiment. And FIG. 15 is a graph also showing exemplary temporal changes in the illuminance of environmental light outside the vehicle measured by the first illuminance sensor 1310a. The first illuminance sensor 1310a measures the illuminance of environmental light outside the vehicle, in units of predetermined illuminance measurement reference period T that is defined to measure the illuminance of environmental light outside the vehicle. The light source management unit 1220 calculates an average value of the illuminances of environmental light outside the vehicle measured by the first illuminance sensor 1310a during the illuminance measurement reference period T. In FIG. 15, the total of four periods T1 to T4 are depicted as the illuminance measurement reference periods T, and the average value of the illuminances of environmental light in each period is indicated by a dashed-dotted line. Though a specific time length of the illuminance measurement reference period T may be determined through experiments in the light of the setting position, precision and so forth of the first illuminance sensor 1310a, T is two seconds, for instance.

As shown in FIG. 15, the light source management unit 1220 divides an illuminance of environmental light outside the vehicle into a predetermined number of illuminance ranges, and checks to see if the average value of the illuminances of environmental light outside the vehicle in each period belongs to any of the divided illuminance ranges. In the example shown in FIG. 15, the illuminance range of environmental light outside the vehicle is divided into four ranges R1 to R4. For example, the average value of the illuminances of environmental light outside the vehicle in the illuminance measurement reference period T1 is classified into an illuminance range R1. And the average value thereof in the illuminance measurement reference period T3 is classified into an illuminance range R4. Note that the number of divided illuminance ranges of environmental light outside the vehicle is not limited to four and may be changed as appropriate in consideration of the precision and the like of the illuminance sensor 1310. The information indicative of the illuminance range derived from the average value of the illuminances of environmental light is sequentially stored in an illuminance storage 1275.

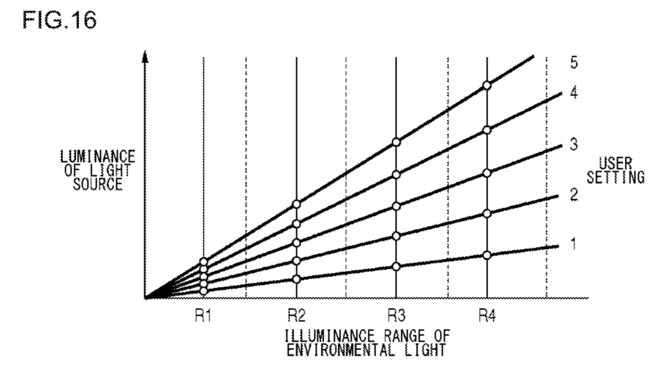

FIG. 16 is another graph to explain how to identify the environmental light outside the vehicle by the light source management unit 1220 according to the present embodiment. FIG. 16 shows a correspondence relation between an illuminance range of environmental light outside the vehicle and a luminance of light to be outputted by the light source 231. The correspondence relations shown in FIG. 16 are stored in a light quantity database 1224 in the storage 1216.

The light source management unit 1220 selects a representative value of the luminance to be outputted by the light source 231 for each of the above-derived illuminance ranges of environmental light outside the vehicle. As shown in FIG. 16, the light source management unit 1220 sets the luminance of light to be outputted by the light source 231, based on the representative values and brightness curves set by the user. In the example shown in FIG. 16, the user selects a brightness curve to be actually set, from among five kinds of brightness cures. This allows the luminance of light outputted by the light source 231, namely the brightness of the virtual image 450 observed through the combiner 400, to vary according to the liking of the user.

Here, the duration time Tc of the luminance that has been set may be longer than or equal to the illuminance measurement reference period T of the illuminance. And if the thus set luminance is kept for Tc seconds, a luminance according to the illuminance stored in the illuminance storage 1275 may be set. This prevents the luminance of light outputted thereby from being incapable of following the change of the illuminance of environmental light at short time intervals when it takes more time to obtain the average value of illuminances of environmental light.

As described above, the light source management unit 1220 references the light quantity database 1224 in the storage 1216 and acquires the luminance of light to be outputted by the light source 231. The light quantity database 1224 is a database that stores the illuminances of environmental light and the luminances of light to be outputted then by the light source 231 in a manner such that the illuminances thereof and the luminances thereof are associated with each other. As shown in FIG. 16, the values of illuminances of environmental light and luminances of light are stored in the light quantity database 1224 such that, when the illuminance of environmental light is large, the luminance of light to be outputted by the light source 231 is larger than when the illuminance of environmental light is small. Specific numerical values stored in the light quantity database 1224 may be determined in consideration of the property of the combiner 400, the size, position and the like of a virtual image to be presented, and so forth, for instance.

The light source management unit 1220 can adjust the light quantity of image display light projected onto the combiner 400, according to the environmental light of the vehicle, by referencing the light quantity database 1224 as shown in FIG. 16. This can enhance the visibility of both the scenery outside the vehicle and the virtual image displayed thereon in an overlaid manner. If, for example, a vehicle has a smoked-glass part in its windshield to shield against direct rays of the sun, there may be cases where the first illuminance sensor 1310a cannot accurately measure the environmental light outside the vehicle. In such a case, it is generally thought that the illuminance measured by the second illuminance sensor 1310b for measuring the environmental light inside the vehicle is larger than that measured by the first illuminance sensor 1310a for measuring the environmental light outside the vehicle. The light source management unit 1220 controls the illuminance of the light source 231 based on the illuminance measured by the second illuminance sensor 1310b, so that the accuracy at which the illuminance is controlled can be enhanced.

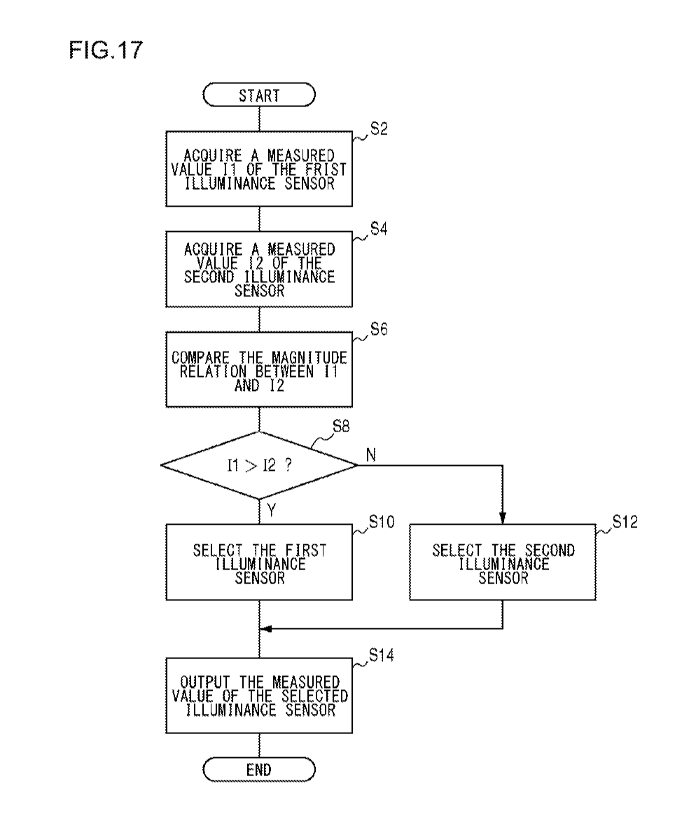

FIG. 17 is a flowchart to explain a flow of a process for selecting an illuminance sensor 1310 by the comparator 1218 according to an embodiment. The processing of this flowchart starts at power-on of the display control apparatus 1000, for instance.

The comparator 1218 acquires an illuminance I1 of environmental light outside the vehicle measured by the first illuminance sensor 1310a (S2). The comparator 1218 also acquires an illuminance I2 of environmental light inside the vehicle measured by the second illuminance sensor 1310b (S4). Subsequently, the comparator 1218 compares the magnitude of the illuminance I1 measured by the first illuminance sensor 1310a with the magnitude of the illuminance I2 measured by the second illuminance sensor 1310b (S6).

If, as a result of comparison in the magnitude between I1 and I2, the illuminance I1 measured by the first illuminance sensor 1310a is larger than the illuminance I2 measured by the second illuminance sensor 1310b (Y of S8), the comparator 1218 selects the first illuminance sensor 1310a as the illuminance sensor 1310 having measured the illuminance value to be outputted to the light source management unit 1220 (S10). If, as a result thereof, the illuminance I1 measured by the first illuminance sensor 1310a is smaller than or equal to the illuminance I2 measured by the second illuminance sensor 1310b (N of S8), the comparator 1218 selects the second illuminance sensor 1310b as the illuminance sensor 1310 having measured the illuminance value to be outputted to the light source management unit 1220 (S12).

The comparator 1218 outputs an output value of the selected illuminance sensor 1310 to the light source management unit 1220 (S14). When the light source management unit 1220 acquires the output value of the illuminance sensor 1310 selected by the comparator 1218, the processing of this flowchart is terminated.

The description has been given hereinbefore of the case where the comparator 1218 compares the illuminance measured by the first illuminance sensor 1310a with the illuminance measured by the second illuminance sensor 1310b and then selects the illuminance sensor 1310 whichever has a greater measured illuminance. Instead, the comparator 1218 may compare the magnitude in between the illuminance measured by the first illuminance sensor 1310a and a predetermined threshold value, and may select the illuminance sensor 1310 whichever has measured an illuminance value to be outputted to the light source management unit 1220, based on the comparison result.

Here, the “predetermined threshold value” is an illuminance sensor selection reference threshold value, based on which the comparator 1218 selects either the first illuminance sensor 1310a or the second illuminance sensor 1310b, and is stored in a threshold value storage 1222 in the storage 1216. Similar to the specific values stored in the light quantity database 1224, a specific value of the illuminance sensor selection reference threshold value may be determined in consideration of the property of the combiner 400, the size, position and the like of the virtual image to be presented, and so forth, for instance.

If, for example, a vehicle has a deeply smoked-glass part in its windshield to shield against the direct sunlight, it is generally thought that the illuminance measured by the first illuminance sensor 1310a is a small value. In the light of this, if the illuminance measured by the first illuminance sensor 1310a falls below the illuminance sensor selection reference threshold value, the comparator 1218 selects the second illuminance sensor 1310b. In this case, as the specific value of the illuminance sensor selection reference threshold value, the illuminance of environmental light outside the vehicle measured via the smoked-glass part provided in the windshield may be determined through experiments.

A description is now given of the installation positions of the illuminance sensors.

As described earlier, the image presentation unit 50 according to the embodiments of the present invention is used after it is mounted to the rear-view mirror 600. The rear-view mirror 600 is normally installed in a center of an upper side of the windshield in a vehicle's passenger compartment. Thus, while the image presentation unit 50 is being mounted to the rear-view mirror 600, the illuminance sensors 1310 are installed such that the installation positions thereof regarding a longitudinal direction of the rear-view mirror 600, namely the installation positions thereof parallel with the rear-view-mirror central line 605, lie within a range of width L (see FIG. 11) of the longitudinal direction of the rear-view mirror 600. Here, the position lying within a range of width L indicates a position located in a range starting from one end of the width in the longitudinal direction of the rear-view mirror 600 up to the other end thereof. Thereby, the illuminance sensors 1310 is installed near the center of the upper side of the windshield, so that the environmental light of the vehicle can be appropriately acquired.

As described earlier, the display control unit 1210 adjusts the light quantity of the outside scenery and the light quantity of the virtual image overlaid via the combiner 400, based on the illuminances acquired by the illuminance sensors 1310. Thus, considering the fact that the combiner 400, onto which the image display light is projected, is placed in a lateral direction (longitudinal direction) of the rear-view mirror 600, it is preferable that the illuminance sensors 1310 are positioned within a range of width L of the rear-view mirror 600 and are located nearer the combiner 400.

On the other hand, the image display substrate housing portion 100 has the first attachment surface 115, on which the attachment plate 581 is to be mounted, and the second attachment surface 117, disposed counter to the first attachment surface 115. And, depending on whether the vehicle, to which the attachment plate 581 is to be mounted, is a right-hand drive vehicle or a left-hand drive vehicle, either the first attachment surface 115 or the second attachment surface 117 is selected for the mounting. Thus, even though the image display substrate housing portion 100 in the image presentation unit 50 is mounted to the attachment plate 581 on either the first attachment surface 115 or the second attachment surface 117, the illuminance sensors 1310 are arranged such that the positions thereof along the longitudinal direction of the rear-view mirror 600 lie within the range of width L of the rear-view mirror 600.

More specifically, when the image display substrate housing portion 100 in the image presentation unit 50 is mounted on the attachment plate 581, the illuminance sensors 1310 are placed in positions located between the pair of holding portions 590. The pair of holding portions 590 are each so fixed to the rear-view mirror 600 as to hold the rear-view mirror 600 tightly. Thus, even though the image display substrate housing portion 100 in the image presentation unit 50 is mounted on the upper surfaces of the holding portions 590 on either the first attachment surface 115 or the second attachment surface 117, the illuminance sensors 1310 are arranged such that the positions thereof lie within the range of width L of the rear-view mirror 600, as long as the illuminance sensors 1310 are placed in positions located between the two holding portions 590.

Further, the top and bottom of the image display substrate housing portion 100 is reversed between when the image display substrate housing portion 100 is mounted to the attachment plate 581 on the first attachment surface 115 and when it is mounted thereto on the second attachment surface 117. Thus, even when the image display substrate housing portion 100 in the image presentation unit 50 is mounted to the attachment plate 581 on either the first attachment surface 115 or the second attachment surface 117, the illuminance sensors are arranged such that the positions thereof in the vertical direction remain unchanged.

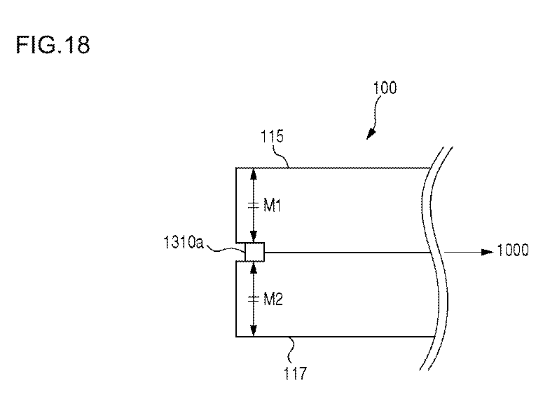

FIG. 18 is a cross-sectional view of the image display substrate housing portion 100 cut along a cross section including the illuminance sensor 1310. As shown in FIG. 18, the illuminance sensor 1310 is arranged in a position such that a distance M1 from the illuminance sensor 1310 to the first attachment surface 115 is equal to a distance M2 from the illuminance sensor 1310 to the second attachment surface 117. As a result, the illuminance sensor 1310 is positioned symmetrical with respect to the first attachment surface 115 and the second attachment surface 117. This makes the installation positions of the illuminance sensors 1310 in the vertical direction identical in both cases. Here, the both cases mean a first case, where the image display substrate housing portion 100 in the image presentation unit 50 is mounted to the attachment plate 581 on the first attachment surface 115, and a second case, where it is mounted thereto on the second attachment surface 117. Hence, the condensing condition of the environmental light can be made identical to each other in the first case and the second case.

As described above in detail, the HUD 10 according to the embodiments according of the present embodiment provides a technology that presents an image, keeping well balance between the brightness in the scenery outside a vehicle and the brightness of image display light overlaid thereon.

The present invention has been described based upon illustrative embodiments. These embodiments are intended to be illustrative only and it will be obvious to those skilled in the art that various modifications to constituting elements and processes could be developed and that such modifications are also within the scope of the present invention.

What is claimed is:

1. A display apparatus for a vehicle comprising:
an illuminance sensor having a first illuminance sensor and a second illuminance sensor, wherein the first illuminance sensor acquires illuminance of environmental light outside the vehicle, and the second illuminance acquires illuminance of environmental light inside the vehicle;
an image presentation unit that selects either the first illuminance sensor or the second illuminance sensor, based a comparison result, and that projects an image display light by controlling luminance of the image display light, generated from an image signal of an image to be displayed, based on the illuminance of environmental light acquired by the selected luminance sensor, wherein the comparison result indicates a magnitude relation between a predetermined illuminance sensor selection reference threshold value, based on which to select either the first illuminance sensor or the second illuminance sensor, and the illuminance of environmental light outside the vehicle acquired by the first illuminance sensor; and
a combiner onto which the image display light is projected,
wherein the image presentation unit is mountable to a rear-view mirror of the vehicle, and
wherein, when the image presentation unit is mounted to the rear-view mirror thereof, the illuminance sensor is arranged such that a position of the illuminance sensor along a longitudinal direction of the rear-view mirror lies within a range of width of the longitudinal direction thereof.

2. The display apparatus for a vehicle according to claim 1, wherein the illuminance sensor is provided on at least one of a front surface and a back surface, disposed counter to the front surface, whichever is one of surfaces constituting a casing of the image presentation unit, wherein the front surface is a surface on a traveling direction side of the vehicle when the image presentation unit is mounted on the rear-view mirror of the vehicle.

3. The display apparatus for a vehicle according to claim 1, further comprising a attachment plate, with which to fix the image presentation unit, and a holding portion secured to the rear-view mirror,
wherein the image presentation unit is mountable to the attachment plate on two surfaces of surfaces constituting a casing of the image presentation unit, wherein the two surfaces thereof are a first attachment surface and a second attachment surface, disposed counter to the first attachment surface,
wherein, when the image presentation unit is mounted to the attachment plate on either the first attachment surface or the second attachment surface, the illuminance sensor is arranged such that the position of the illuminance sensor along the longitudinal direction of the rear-view mirror lies within the range of width of the longitudinal direction thereof.

4. The display apparatus for a vehicle according to claim 3, wherein the holding portion has two securing members with which to fix the rear-view mirror in such a manner as to hold the rear-view mirror, and
wherein, when the image presentation unit is mounted to the attachment plate, the illuminance sensor is arranged such that the position of the illuminance sensor along the longitudinal direction of the rear-view mirror lies within the range of width of the longitudinal direction thereof.

5. The display apparatus for a vehicle according to claim 3, wherein, when the image presentation unit is mounted to the attachment plate on either the first attachment surface or the second attachment surface, the illuminance sensor is arranged such that a position thereof in a vertical direction remains unchanged.

6. The display apparatus for a vehicle according to claim 1, wherein the image presentation unit selects either the first illuminance sensor or the second illuminance sensor, based a comparison result, which indicates a magnitude relation between the illuminance of environment light outside the vehicle acquired by the first illuminance sensor and the illuminance of environment light inside the vehicle acquired by the second illuminance sensor.

7. The display apparatus for a vehicle according to claim 6, wherein the image presentation unit compares the magnitude relation between the illuminance of environment light outside the vehicle acquired by the first illuminance sensor and the illuminance of environment light inside the vehicle acquired by the second illuminance sensor, and selects the first illuminance sensor or the second illuminance sensor, whichever has a greater illuminance acquired.
